(19) United States
(12) Patent Application Publication
(10) Pub. No.: US 2015/0254717 A1
(43) Pub. Date: Sep. 10, 2015

(54) Identifying Related Activities Occurring in Geographic Proximity of Each Other

(71) Applicant: GOOGLE INC., Mountain View, CA (US)

(72) Inventor: Masanori Goto, Tokyo (JP)

(21) Appl. No.: 14/636,891

(22) Filed: Mar. 3, 2015

Related U.S. Application Data
(60) Provisional application No. 61/947,854, filed on Mar. 4, 2014.

(51) Int. Cl. G06Q 30/02; G06Q 50/00

(52) U.S. Cl. CPC G06Q 30/0259; G06Q 30/0255; G06Q 50/01; G06Q 30/0261

(57) ABSTRACT

To efficiently provide commercial content in geographic applications, an indication of first visits to a first business entity having a first geographic location, by a first subset of a group of users, is received. An indication of second visits to a second business entity having a second geographic location, by a second subset of the group of users, is also received. A correlation coefficient indicative of correlation between the first visits and the second visits is determined. When it is determined that the correlation coefficient exceeds a certain threshold value, commercial content related to the second business entity is generated, for display at user devices located at the first physical location.

### FIELD OF TECHNOLOGY

The present disclosure relates generally to geographic applications and, more particularly, to provided targeted commercial content in digital mapping applications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many portable computing devices support software applications that display interactive digital maps. Some of these software applications are developed primarily for providing interactive digital maps. Other software applications, such as web browsers, may display interactive digital maps along with other content. In any case, these applications generally display the types of information traditionally provided on papers maps, at various levels of magnification (zoom levels). In addition to “traditional” geographic content, some of these applications provide commercial geographic content, such as advertisements for various businesses or coupons, for example.

### SUMMARY

To help brick-and-mortar businesses advertise their services more effectively, a system of this disclosure automatically identifies potentially correlated user visits to business locations. Based on a determined correlation between visits to two business entities, the system generates commercial content related to one of these entities for display at portable devices at or near the other one of the entities. Additionally or alternatively, the system can automatically generate a recommendation for a party operating one of these business entities to advertise at or near the location of the other business entity.

One embodiment of these techniques is a method for providing efficiently providing commercial content in geographic applications. The method includes receiving an indication of a first plurality of visits to a first business entity having a first geographic location, by a first subset of a plurality of users, and receiving an indication of a second plurality of visits to a second business entity having a second geographic location, by a second subset of the plurality of users. The method further includes determining a correlation coefficient indicative of correlation between the first plurality of visits and the second plurality of visits, determining whether the correlation coefficient exceeds a threshold value, and when the correlation coefficient exceeds a threshold value, providing commercial content related to the second business entity, for display at user devices located at the first physical location.

Another embodiment of these techniques is a system for providing automatic guidance regarding efficient use of commercial content in geographic applications. The system includes a communication interface and processing hardware coupled to the communication interface. The processing hardware is configured to receive an indication of a first plurality of visits to a first business entity having a first geographic location, by a first subset of a plurality of users and an indication of a second plurality of visits to a second business entity having a second geographic location, by a second subset of the plurality of users. The processing hardware is further configured to determine a correlation coefficient indicative of correlation between the first plurality of visits and the second plurality of visits, determine whether the correlation coefficient exceeds a threshold value, and, when the correlation coefficient exceeds a threshold value, provide commercial content related to the second business entity, for display at user devices located at the first physical location.

Yet another embodiment of these techniques is a method for providing automatic guidance regarding efficient use of commercial content in geographic applications. The method includes receiving indications of a plurality of paths traversed by a plurality of users within a geographic area, and corresponding time indications; identifying a first business entity at a first geographic location and a second business entity at a second geographic location within the geographic area, where several of the plurality of paths include the first geographic location and the second geographic location within a certain time interval; determining, by the one or more computing devices, a probable causal link between visits to the identified first business entity and the second business entity; and generating an electronic message for a party that operates the first business entity, including a recommendation to provide the commercial content on behalf of the party at the first geographic location.

### BRIEF DESCRIPTION OF THE DRAWINGS

FIG. 1 illustrates an example computing system in which related user activities can detected to provide commercial geographic content, in accordance with the techniques of this disclosure;

FIG. 2 schematically illustrates user visits to several business entities at different geographic locations, in which the system of FIG. 1 can recognize related user activities;

FIG. 3 is a flow diagram of an example method for generating commercial content for display at a geographic location in view of correlated user activities, which can be implemented in the system of FIG. 1; and

FIG. 4 is a flow diagram of another example method for generating commercial content, which can be implemented in the system of FIG. 1.

### DETAILED DESCRIPTION

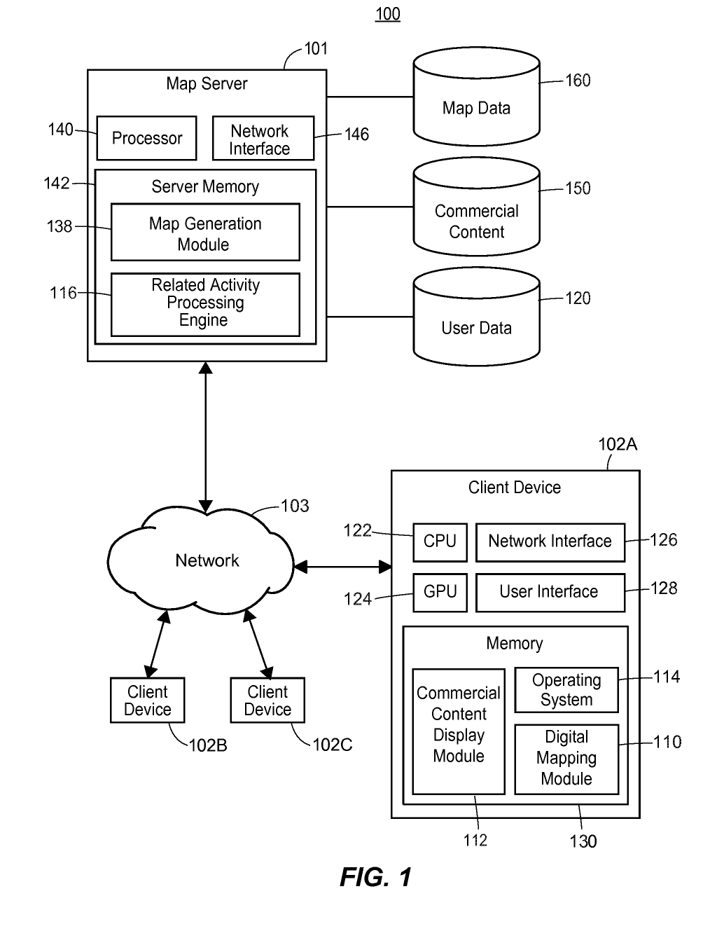

FIG. 1 illustrates an example computing system 100 in which commercial content can be efficiently provided via portable user devices, and/or recommendations concerning placement of commercial content can be automatically provided for operators of brick-and-mortar business entities. The system 100 includes a map server 101 coupled to portable client devices such as client devices 102A-C via a communication network 103. For simplicity, only the client device 102A is illustrated in detail. It will be understood that the client devices 102B and 102C can include a generally similar structure.

The portable client device 102A can implement a digital mapping module 110 configured to generate digital map images and a commercial content display module 112 to display geographically relevant commercial content. The map server 101 can implement a related activity processing engine 116 to identify probable causal relationships between activities of the users operating the client devices 102A-C and generate commercial content specific to a client device in view of these probable causal relationships and/or automatically generate recommendations regarding placement of commercial content for business entities.

To identify probable causal relationships, the related activity processing engine 116 can operate on user data 120 collected from a relatively large number of users operating portable client devices 102A-C and similar devices. These users can visit various businesses in a certain geographic area, such as entertainment venues such as concert halls and movie theaters, stores, bars, and food establishments. However, the user data 120 need not indicate activities of individually identifiable users. In some implementations, the user data 120 is aggregate data that does not associate events and activities with specific user. As discussed in more detail below, the related activity processing engine 116 can determine that, for example, many users who see a movie at a certain theater at night also tend to visit a nearby bar afterward. Depending on the amount of data available to the related activity processing engine 116, the degree of certainty associated with certain identified correlations can vary. The users' client devices can report their locations and the corresponding time stamps to the system 100 for storage as part of the user data 120. The users can operate certain controls and/or install certain applications to allow their portable devices to report this data.

The client device 102A in general can be any suitable portable computing device. By way of example, the client device 102 may be a smartphone, a tablet computer, a laptop computer, etc. As illustrated in FIG. 1, the client device 102A can include one or more processor(s) such as a central processing unit (CPU) 122, a graphics processing unit (GPU) 124, a network interface 126, a user interface 128, and a memory 130. The client device 102A in some implementations can include fewer components than illustrated in FIG. 1 or, conversely, include additional components (omitted from FIG. 1 for simplicity). For example, the client device 102A can be equipped with a positioning module such as Global Positioning System (GPS) chip.

The digital mapping module 110 and the commercial content display module 112 can be stored in the memory 130 as sets of instructions executable on the one or more processor(s) 122 and/or the GPU 124. The digital mapping module 110 can be a special-purpose application available at an online application store disposed at the map server 101 or an application server (not shown). A user of the client device 102A may retrieve a copy of the digital mapping module 110 from the application server and install the retrieved copy of the mapping application on the client device 102A. In other implementations, the digital mapping module 110 can be a software component, such as a plug-in, that operates in a web browser (e.g., Google Chrome® or Apple's Safari®) or another application.

The memory 130 may be tangible, non-transitory memory and may include any types of suitable memory modules, including random access memory (RAM), read-only memory (ROM), a hard disk drive, flash memory, or other types of memory. In addition to the software components 110 and 112, the memory 130 may store an operating system 114 and one or more local applications or modules (not shown). The operating system 114 may be any type of suitable operating system, and the one or more local applications may include a variety of installed applications.

The user interface 128 can include one or components such as a touchscreen, a screen along with a keyboard and a mouse, speakers, etc. The network interface 126 can support such communication protocols such as TCP/IP, for example, layered over wired or wireless protocols.

With continued reference to FIG. 1, the map server 101 can include one or more general-purpose processor(s) 140, a non-transitory computer-readable memory 142, and a network interface 146 to communicate with the client devices 102A-C and databases 120, 150, and 160. The map server 101 in some embodiments can include additional components or multiple instances of the components illustrated in FIG. 1. Further, in some implementations the system 100 includes multiple independent servers separately providing mapping data and commercial data. These servers can be associated with a same online service or separate online services maintained by different operators.

The map database 160 can store map content such as street and road information, topographic data, satellite imagery, information related to public transport routes, information about businesses or other points of interest (POIs), information about current traffic conditions, etc. The map database 160 can store the map data in any suitable format or set of formats such as vector graphics, raster images, etc. Map data in the database 160 can be divided into map tiles of a certain size, which can be specific to the zoom level. In some scenarios, one or several of the client devices 102A-C receive data from the map database 160 via the map server 101 to provide interactive digital maps via the respective user interfaces.

The commercial content database 150 can store advertisements, offers, coupons, etc. received from various business entities, including brick-and-mortar businesses. Each description of a unit of commercial content can include various rules for displaying the commercial content at client devices. For example, operators of certain businesses can request that their advertisements be displayed at certain times and certain locations. In general, the commercial content database 150 can store rules of any desired complexity for providing commercial content to users via portable devices.

In some cases, the related activity processing engine 116 automatically creates rules for displaying commercial content based on detected correlations between visits to business entities at certain geographic locations. For example, an operator of a business B₁ at geographic location L₁ can request that its commercial content be displayed at locations where users are most likely to respond to the offer, advertisement, coupon, etc. The related activity processing engine 116 can detect a sufficiently high correlation (e.g., with the correlation coefficient exceeding a certain threshold value) between visits to the business B₁ and previous visits to business B₂ at location L₂, and automatically create a rule according to which commercial content for business B₁ is more frequently displayed at location L₂.

In some cases, the related activity processing engine 116 uses the detected correlations to generate electronic messages for business owners and operators including recommendations for efficient placement of commercial content. To continue with the example above, the related activity processing engine 116 can generate an email message for the operator of business B₁ with a recommendation to advertise at location L₂. Other suitable types of electronic messages include, for example, automatic notifications and recommendations provided via a user interface of an online service for assisting people with building their web sites.

In operation, the user of the client device 102A can interact with the digital mapping module 110 via the user interface 128. The user can select a geographic area, and in response the digital mapping module 110 can request the corresponding map data from the map server 101. Alternatively, the digital mapping module 110 can automatically request map data for an area including the current location of the client device 102A. In response, the map generation module 138 can provide map data for rendering the digital map of the geographic area from the map database 160 and, in some cases, provide commercial content from the database 150, selected and displayed in accordance with the rules stored in the database 150. Referring again to the example scenario above, when the user of the client device 102A is visiting business B₂ or, more generally, is at the location L₂, the map server 101 can provide commercial content related to business B₁ for display with the digital map or otherwise via the user interface 128.

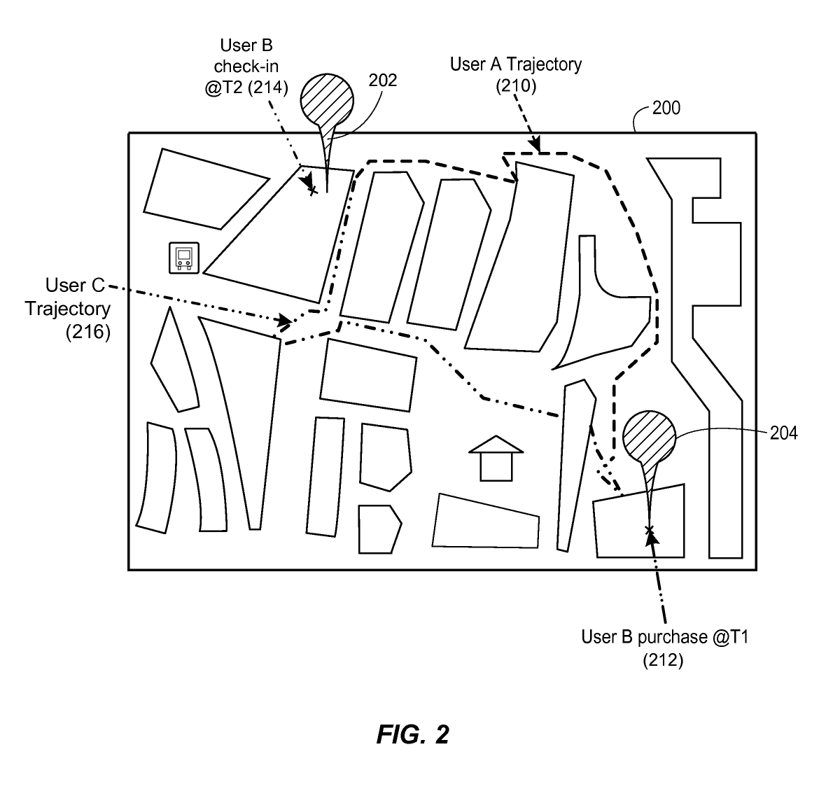

To further explain example operation of the related activity processing engine 116, FIG. 2 schematically illustrates user activities related to businesses 202 and 204 in a geographic region 200. The locations of the businesses 202 and 204 are represented by locations markers. In the illustrated scenario, user A visits business 204 and walks to business 202 along a path or trajectory 210. Because user A operates certain controls to allow her portable device to report its current location at different times, the related activity processing engine 116 can reconstruct the trajectory 210 both spatially and temporally to determine, for example, that user A likely transacted business at business 202 as well as at business 204.

The portable device of user B may not report its current location. However, user B may “check in” at the location corresponding to businesses 204 at a certain time (even 212) and subsequently check in at the location corresponding to business 202 (event 214). If the user shares this data with the map server 101, the related activity processing engine 116 may determine that user B likely transacted business at business 202 as well as at business 204.

With continued reference to FIG. 2, user C visits business 204 and walks to business 202 along a trajectory 216. The trajectory 216 can be very different from the trajectory 210, and the times between visits to businesses 202 and 204 can be different for users A and B.

Based on the activity of the users A, B, and C, the related activity processing engine 116 can determine a probable causal link between visits to businesses 202 and 204. More particularly, the related activity processing engine 116 can determine the probable causal link based on the order in which these users visited the businesses, the distance between the businesses, and times between visits, etc. To this end, the related activity processing engine 116 can apply any suitable statistical technique, including those known in the art. Of course, the related activity processing engine 116 typically considers a sample including a large number of trajectories and check-ins to identify activities such as those of FIG. 2. The sample can include numerous user trajectories, check-ins, etc. that pass through only one of the businesses 202 and 204, and the related activity processing engine 116 can determine how many of the users who visit one of the businesses 202 and 204 also visit the other one, and how many do so in the same order as users A, B, and C. Thus, if users A, B, and C are the only users out of hundreds who visit the businesses 202 and 204 individually, the related activity processing engine 116 can generate a correlation coefficient lower than a threshold value, and determine that there probably is no causal link between visits to businesses 202 and 204. On other hand, if a large percentage of the users visit businesses 202 and 204 similarly to users A, B, and C, the related activity processing engine 116 can generate a correlation coefficient higher than the threshold value, and determine that there probably is a causal link between visits to businesses 202 and 204.

In addition to direct location reports and check-ins, the related activity processing engine 116 can utilize other indications of users' actual visits to places, virtual “visits” to places using social networking services, and/or other indications of users' interest in places. For example, a user can review a place by assigning a certain number of stars via an online business review service, an online interactive mapping service, a social network, etc. The review can be private or public. As another example, a user can submit a search query related to a place via a search engine or a geographic query related to the place via an interactive mapping service.

Further, the related activity processing engine 116 can analyze time patterns, such as weekday/week-end patterns or dinner/lunch time patterns or summer/winter, when attempting to detect a probable causal link between visits. More specifically, visits to a pair of places may be strongly correlated at lunchtime but not at other times. Providing commercial content at a related place at lunchtime therefore may make sense, but providing the same commercial content at the same location at other times may not be useful. Still further, the related activity processing engine 116 can consider other factors, such as rain, cloudiness, or other weather factors.

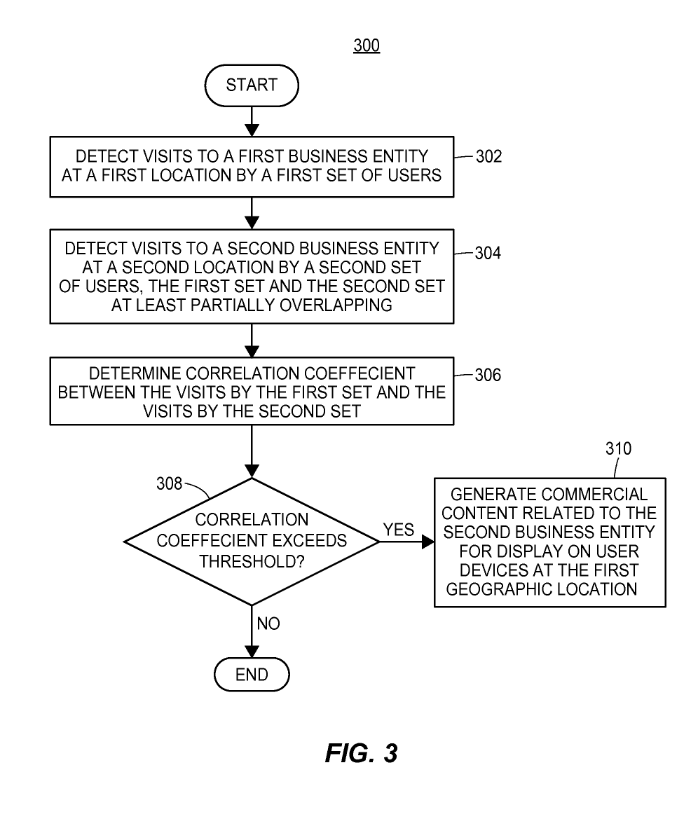

Next, FIG. 3 illustrates a flow diagram of an example method 300 for generating commercial content for display at a geographic location in view of correlated user activities, which can be implemented in the related activity processing engine 116, for example. The method 300 can be implemented as a set of instructions stored on a computer-readable memory and executable on one or more processors (e.g., the processors 140).

At block 302, visits to a first business entity by a first set of users are detected. For example, a data set describing a large number of user trajectories, check-ins, coupon cash-ins, electronic purchase confirmations, etc. can be analyzed to determine that some of the users visited the first business entity disposed at a first location. At block 304, the data set is analyzed further to determine that some of the users visited a second business entity disposed at a second location. The sets of users who visited the first business entity and the first business entity can overlap to define a certain subset of the users. As discussed above, the size of this subset (and, in some cases, the ratio of the subset to the overall set of users in the data set) can be one of the factors considered in identifying a possible causal link between visits to the first business entity and the second business entity.

At block 306, the correlation coefficient indicative of the possible causal link is determined using any suitable statistical technique. The correlation coefficient is compared to a certain predefined threshold at block 308. If it is determined that the correlation coefficient exceeds the threshold, the flow proceeds to block 310. Otherwise, the method 300 ends.

At block 310, commercial content related to the second business entity is generated for display on user devices at the first geographic location. In some embodiments, the method 300 can produce only of several factors affecting display of commercial content. Thus, at block 310, the method 300 in these cases can generate a signal that will weigh in favor of generating commercial content related to the second business entity for display on user devices at the first geographic location, rather than directly generate this content. More generally, however, commercial content related to the second business entity can be generated for display on user devices at multiple locations directly or indirectly related to the first geographic location. As one example, commercial content related to the second business entity can be provided in response to the user submitting a search query related to the first geographic location.

Further, in some embodiments, the method 300 includes generating an electronic message including a recommendation for the operator of the second business entity. Depending on the implementation, this electronic message is generated prior to the act illustrated in block 310 or instead of the act illustrated in block 310.

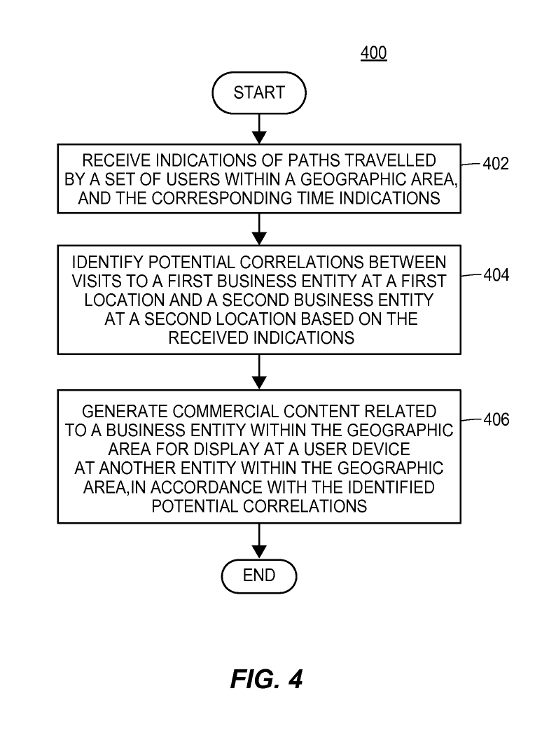

FIG. 4 is a flow diagram of another example method 400 for generating commercial content, which can be implemented in the system of FIG. 1. Similar to the method 300, the method 400 can be implemented as a set of instructions stored on a computer-readable memory and executable on one or more processors (e.g., the processors 140).

At block 402, indications of paths traveled by users and the corresponding time indications are received. Next, at block 404, potential correlations between visits to a first business entity and a second business entity are received. These businesses are disposed at a first location and second location, respectively. These potential correlations can be detected using the techniques outline above, for example, or in another suitable manner.

At block 406, commercial content is generated and/or selected in accordance with the detected correlations. For example, advertisements, offers, coupons, etc. related to the first business entity can be generated for display at portable devices at the second geographic location.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for efficiently generating content for display at portable devices in view of correlated visits to businesses through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for providing efficiently providing commercial content in geographic applications, the method comprising:
receiving, by one or more computing devices, an indication of a first plurality of visits to a first business entity having a first geographic location, by a first subset of a plurality of users;
receiving, by the one or more computing devices, an indication of a second plurality of visits to a second business entity having a second geographic location, by a second subset of the plurality of users;
determining, by the one or more computing devices, a correlation coefficient indicative of correlation between the first plurality of visits and the second plurality of visits;
determining whether the correlation coefficient exceeds a threshold value; and
when the correlation coefficient exceeds a threshold value, providing, by the one or more computing devices, commercial content related to the second business entity, for display at user devices located at the first physical location.

2. The method of claim 1, further comprising:
when the correlation coefficient exceeds a threshold value, generating, by the one or more computing devices, an electronic message for a party that operates the second business entity, wherein the electronic message includes a recommendation to provide the commercial content on behalf of the party at the first geographic location; and
transmitting the electronic message to the party.

3. The method of claim 1, wherein receiving the indications of the first and the second pluralities of visits including receiving check-in indications for at least some of the first subset and the second subset of the plurality of users, each check-in indication generated by a social networking service.

4. The method of claim 1, wherein determining the correlation coefficient includes comparing, for those of the plurality of the users who are both in the first subset and the second subset, respective times at which the users visited the first business entity and the second business entity.

5. The method of claim 4, wherein determining the correlation coefficient further includes determining a distance between the first geographic location and the second geographic location.

6. The method of claim 4, wherein comparing the respective times at which the users visited the first business entity and the second business entity is includes comparing the respective times in view of at least one of (i) a time of day, (ii) a season, or (iii) a weather when the users visited the first business entity and the second business entity.

7. The method of claim 1, wherein determining the correlation coefficient includes reconstructing, by the one or more processors, paths traversed by at least some of the plurality of users in a geographic area that includes the first geographic location and the second geographic location.

8. A system for providing automatic guidance regarding efficient use of commercial content in geographic applications, the system comprising:
a communication interface; and
processing hardware coupled to the communication interface, the processing hardware configured to:
receive (i) an indication of a first plurality of visits to a first business entity having a first geographic location, by a first subset of a plurality of users and (ii) an indication of a second plurality of visits to a second business entity having a second geographic location, by a second subset of the plurality of users,
determine a correlation coefficient indicative of correlation between the first plurality of visits and the second plurality of visits,
determine whether the correlation coefficient exceeds a threshold value, and
when the correlation coefficient exceeds a threshold value, provide commercial content related to the second business entity, for display at user devices located at the first physical location.

9. The system of claim 8, wherein the processing hardware is further configured to:
when the correlation coefficient exceeds a threshold value, generate an electronic message for a party that operates the second business entity, wherein the message includes a recommendation to provide the commercial content on behalf of the party at the first geographic location; and
transmit the electronic message to the party.

10. The system of claim 8, wherein the commercial content includes at least one of (i) an advertisement, (ii) a coupon, or (iii) an offer.

11. The system of claim 8, wherein to receive the indications of the first and the second pluralities of visits, the processing hardware is configured to receive check-in indications for at least some of the first subset and the second subset of the plurality of users, each check-in indication generated by a social networking service.

12. The system of claim 8, wherein to determine the correlation coefficient, the processing hardware is configured to compare, for those of the plurality of the users who are both in the first subset and the second subset, respective times at which the users visited the first business entity and the second business entity.

13. The system of claim 12, wherein to determine the correlation coefficient, the processing hardware is further configured to determine a distance between the first geographic location and the second geographic location.

14. The system of claim 8, wherein to determine the correlation coefficient, the processing hardware is further configured to reconstruct paths traversed by at least some of the plurality of users in a geographic area that includes the first geographic location and the second geographic location

15. A method for providing automatic guidance regarding efficient use of commercial content in geographic applications, the method comprising:
receiving, by one or more computing devices, indications of a plurality of paths traversed by a plurality of users within a geographic area, and corresponding time indications;
identifying, by the one or more computing devices, a first business entity at a first geographic location and a second business entity at a second geographic location within the geographic area, wherein several of the plurality of paths include the first geographic location and the second geographic location within a certain time interval;
determining, by the one or more computing devices, a probable causal link between visits to the identified first business entity and the second business entity; and
generating, by the one or more processors, an electronic message for a party that operates the first business entity, including a recommendation to provide the commercial content on behalf of the party at the first geographic location.

16. The method of claim 15, further comprising providing, by the one or more computing devices, commercial content related to the second business entity, for display at user devices located at the first physical location.

17. The method of claim 15, wherein determining the probable causal link further includes determining, by the one or more computing devices, a distance between the first geographic location and the second geographic location.

18. The method of claim 15, wherein the indications of a plurality of paths and the corresponding time indications includes receiving sequences of tuples, each including geographic coordinates and a time stamp.

19. The method of claim 18, wherein determining the probable causal link between visits includes determining at least one of (i) a time of day, (ii) a season, or (iii) a weather when the users visited the first business entity and the second business entity

20. The method of claim 15, wherein the commercial content includes at least one of (i) an advertisement, (ii) a coupon, or (iii) an offer.
